(19) United States
(12) Patent Application Publication
(10) Pub. No.: US 2017/0165668 A1
(43) Pub. Date: Jun. 15, 2017

(54) Liquid Phase Quadrupole Particle Filter

(71) Applicant: President and Fellows of Harvard College, Cambridge, MA (US)

(72) Inventors: Alessandra Ferzoco, Cambridge, MA (US); Yeon Jae KO, Cambridge, MA (US)

(21) Appl. No.: 15/117,033

(22) PCT Filed: Feb. 6, 2015
(86) PCT No.: PCT/US15/14831

§ 371 Date: Aug. 5, 2016

Related U.S. Application Data
(60) Provisional application No. 61/936,787, filed on Feb. 6, 2014.

(51) Int. Cl. B01L 3/00; H01J 49/04

(52) U.S. Cl. CPC B01L 3/502761; H01J 49/0431; B01L 2200/0652; B01L 2200/0668; B01L 2300/0645; B01L 2400/0415; B01L 3/502707

(57) ABSTRACT

A multiple layer device includes a channel layer having a channel to carry a liquid having particles of multiple sizes, a first electrode layer having a first pair of electrodes disposed about the channel, and a second electrode layer having a second pair of electrodes disposed about the channel, wherein the first and second pairs of electrodes are arranged to form a quadrupole about the channel when the electrodes are coupled to an electrical signal adapted to create a quadrupole trap.

### RELATED APPLICATION

This application claims priority to U.S. Provisional Application Ser. No. 61/936,787, filed Feb. 6, 2014, which is incorporated herein by reference.

### BACKGROUND

The size purification of nanometer to micrometer scale particles is necessary for many applications and typically involves the use of batch processes. A quadrupole mass spectrometer produces a continuous purified stream of mass-to-charge resolved ions.

However sample losses due to vacuum interfacing, ionization, and collection are extensive, which is especially problematic for bulk collection in preparative mass spectrometry.

### SUMMARY

A multiple layer device includes a channel layer having a channel to carry a liquid having particles of multiple sizes, a first electrode layer having a first electrode disposed about the channel, and a second electrode layer having a second electrode disposed about the channel, wherein the first and second electrodes are arranged to form a quadrupole about the channel when the electrodes are coupled to an electrical signal adapted to create a quadrupole trap.

A method includes providing a liquid having particles of various sizes to a channel sandwiched between two segmented electrodes arranged to form a quadrupole about the channel, applying an electrical signal to the two segmented electrodes to create a quadrupole trap about the channel such that particles of a selected size are captured by the quadrupole trap and other size particles are ejected away from the quadrupole trap, providing an output stream of liquid and selected size particles in a central channel proximate the quadrupole trap, removing liquid and the other size particles via a waste channel positioned proximate the quadrupole trap.

A further method includes forming a first segmented electrode layer on a substrate via metal sputtering and etching to form a first electrode having two pads connected by a rectangular section, forming a channel layer on the first electrode layer, the channel layer having a separation channel crossing the rectangular section and changing into a central channel and two “Y” shaped peripheral waste channels, forming a second segmented electrode layer on a substrate via metal sputtering and etching to form a second electrode having two pads connected by a second rectangular section, and bonding the second electrode layer to the channel layer opposite the first electrode layer such that the electrode pads in each layer are positioned diagonally from each other and do not overlap with the other electrode pads, and wherein the rectangular sections of both electrode layers overlap to form a quadrupole.

### BRIEF DESCRIPTION OF THE DRAWINGS

FIG. 1 is a perspective view of a device having a quadrupole electrode arrangement according to an example embodiment.

FIG. 2 is a top block diagram of the example device of FIG. 1.

FIG. 3 is a top block diagram illustrating a liquid channel of the example device of FIG. 1.

FIG. 4 is a top block diagram illustrating a separating channel of the example device of FIG. 1.

FIG. 5 is a perspective block diagram illustrating flow through a quadrupole device according to an example embodiment.

FIG. 6 is a perspective block diagram cross section of the device taken along line 5-5 in FIG. 6 illustrating particle separation according to an example embodiment.

FIG. 7 is a block flow diagram illustrating electrode patterning according to an example embodiment.

FIG. 8 is a block flow diagram illustrating flow channel fabrication according to an example embodiment.

FIG. 9 is a block flow diagram illustrating further flow channel fabrication according to an example embodiment.

FIG. 10 is a block flow diagram illustrating sealing a top electrode layer to a bottom electrode and middle channel layer according to an example embodiment.

FIG. 11 is a block flow diagram illustrating electrode fabrication on a plastic substrate according to an example embodiment.

FIG. 12 is a block flow diagram illustrating transparent electrode fabrication according to an example embodiment.

FIG. 13 is a block flow diagram illustrated channel fabrication for plastic substrate device according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

A device utilizes a quadrupole electrode arrangement about a liquid main channel to separate target size particles in the liquid by size as the liquid flows through the main channel. The quadrupole may operate directly on a flowing liquid phase solution thereby eliminating the losses associated with prior preparative mass spectrometry methods. Separated particles are transported by the channel to an output, and waste channels are positioned to divide off the main channel to remove waste containing particles that are larger and smaller than the target size particles. The waste channels may be “Y” shaped, with the angle extending off the main channel being less than 90 degrees to reduce turbulence. The waste channels may also be symmetrical to further enhance waste removal.

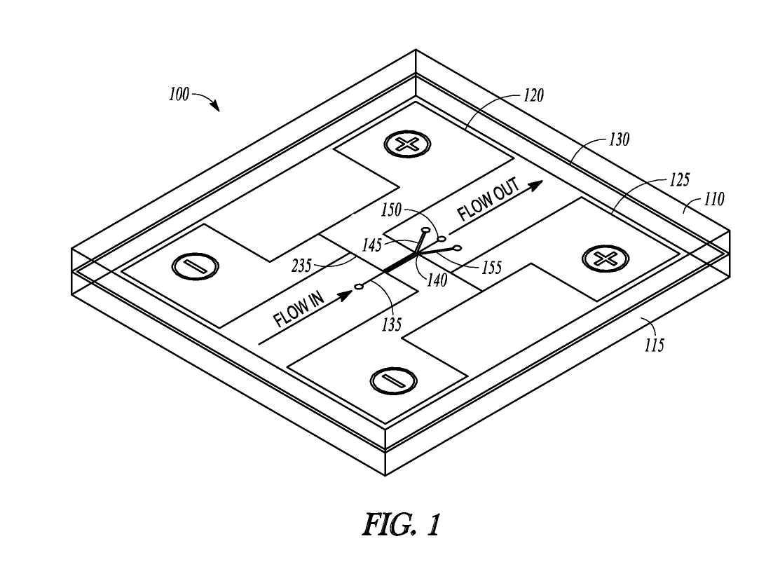

FIG. 1 is a perspective block diagram of a device 100. Top and bottom layers 110 and 115 respectively include top and bottom patterned metallic electrodes 120 and 125 such that when sandwiched around a middle layer 130 the electrodes form a four-electrode layout of a conventional quadrupole. The middle layer 130 physically separates the top and bottom electrodes and also forms a channel 135 for fluid flow. An output flow 140 is divided into three channels 145, 150, 155 where particles to be confined within and flowing through the center channel 150 leaving minimal traces in the Y-shaped peripheral channels 145 and 155.

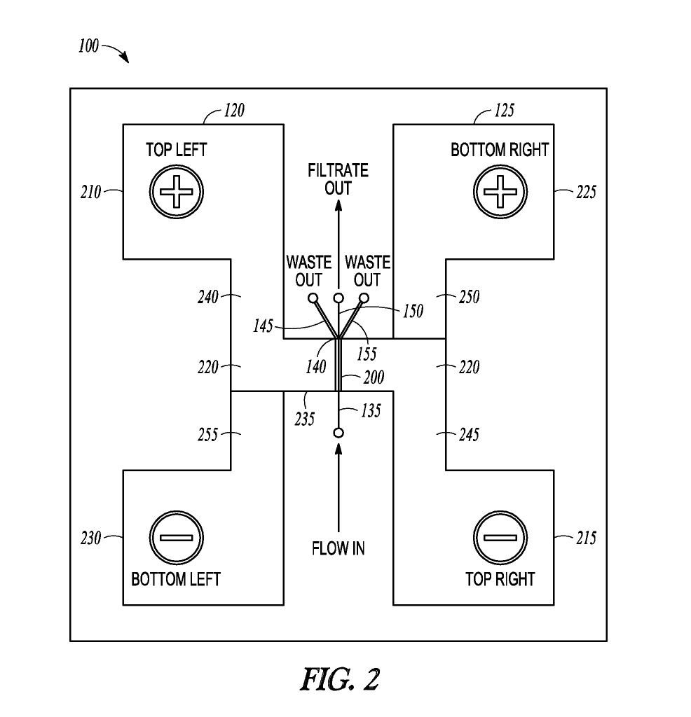

FIG. 2 is a top block diagram view of the device 100 illustrating a separation channel 200 under a trap created by the electrodes 120 and 125 where the electrodes overlap. The designations top left, bottom right, bottom left, and top right indicate the position of respective electrodes about the separation channel 200. The top electrode 120 has one end labeled as a positive end at 210 and a negative end at 215 on opposite sides of the separation channel. The positive end 210 is shown as being to the left of the separation channel 200 and the negative end 210 is shown as being to the left of the separation channel 200 in one embodiment, but on an opposite corner of the device 100. The top electrode has a segmented middle portion 220 connected to respective positive and negative ends and crossing the separation channel. The middle portions 220 may be as wide as the separation channel is long in some embodiments and as illustrated in FIG. 2, and are separated by a gap in the middle of the separation channel in one embodiment.

Similarly, the bottom electrode 125 is shown labeled with a positive end 225 opposite the separation channel from the positive end 210 of the top electrode 120 and a negative end 230 opposite the separation channel 200 from the negative end 215 of the top channel 120. The ends of the bottom electrode are again located on opposite corners of the device 100 and are coupled via a segmented middle portion 235 crossing the separation channel 200 and separated by a gap in the middle of the separation channel in one embodiment, but hidden in this view by middle portion 220 of the top electrode 120. The middle portion 235 may be as wide as the separation channel is long in some embodiments.

The electrode ends 210, 215, 225 and 230 are shown as contact pads having a larger area than other portions of the electrodes 120 and 125. The pads are useful to couple the top electrode to a signal source. Each of the pads is coupled by connecting portions 240, 245, 250, 255 extending in generally the same direction as the channel 135, connecting the respective pads to the middle portions 235 which extend between the connecting portions on respective top and bottom layers 110, 115 to overlap across the separation channel 200. In one embodiment, the connecting portions 240, 245, 250, 255 are laterally separated from each other opposite the channel 135.

In one embodiment, the quadrupole electrodes actually extend along the entire device. Once the particles are in their respective filtered and waste channels the electric field no longer changes the outcome, allowing the field to be extended along the entire device if convenient for ease of fabrication, design, or otherwise.

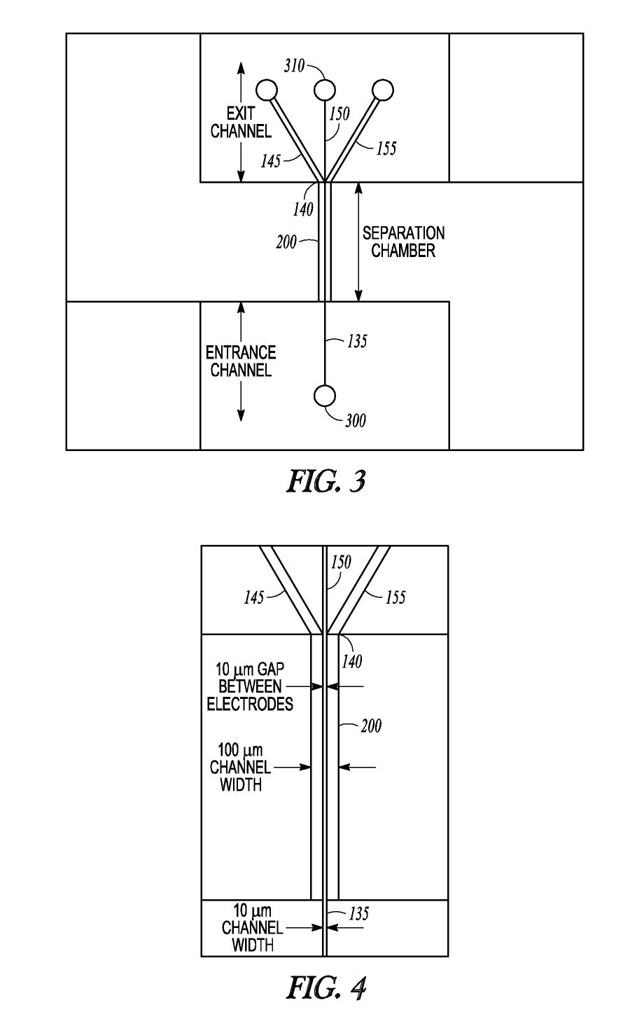

Further detail of the separation channel 200, also referred to as a separate chamber showing enlarged portions of FIG. 2 is provided in top block diagram views of FIGS. 3 and 4. FIG. 3 illustrates a channel 135 entrance at 300 and a channel 150 exit at 310. The separation channel 200 is illustrated as wider than channel 135, and extends in one embodiment an entire length of electrode 120 and 125 overlap. In one embodiment, SiO₂ is grown above the bottom electrode layer and subsequently dry etched to reveal channel patterns. One example design has a 10 μm gap between electrodes and a 100 μm channel width.

FIG. 4 is a top block diagram illustrating a separating channel of the example device of FIG. 1. The gap of segmented middle portions of the electrodes is illustrated in FIG. 4 as a 10 μm gap. The gap may vary in further embodiments.

FIG. 5 is a perspective block diagram of device 100 illustrating flow through a quadrupole device according to an example embodiment.

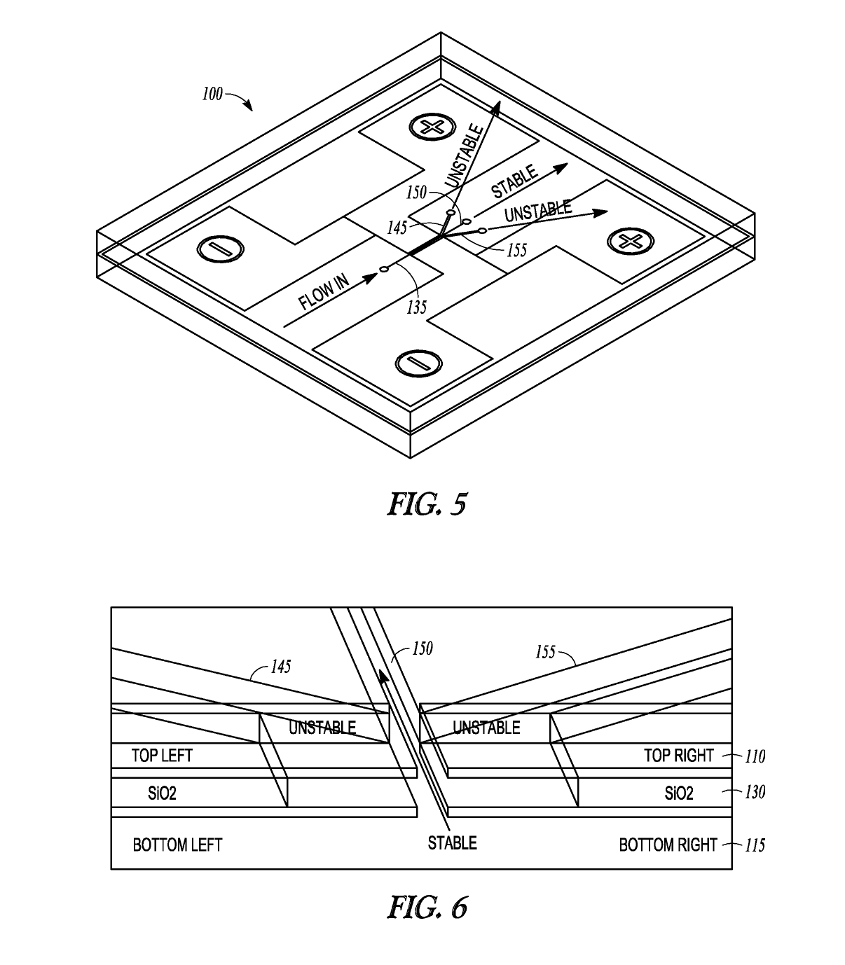

FIG. 6 is a perspective block diagram cross section of the device taken along line 5-5 in FIG. 6 illustrating particle separation according to an example embodiment. Stable particles are confined within a trapping volume between the four electrodes and exit through the center channel 150. Unstable particles are ejected and exit via the side waste channels 145 and 155.

The angle between the main channel and the waste channels may be 48 degrees, 30 degrees, or other angles in various embodiments. Using some photolithography techniques, the smallest angle currently obtainable is about 5 degrees.

Channel dimensions may be based on the following considerations. The height may be a function of the electrode geometry because the top and bottom of the channel also support the electrodes in some embodiments. The width of the entrance channel is meant to be of the dimension of the quadrupole so that all particles entering a separation chamber start within the quadrupolar field (for example 10 μm in one embodiment).

The width of the separation chamber is meant to be large enough that a particle ejected from the quadrupole has a low probability of diffusing back into it. For one example geometry, the width is 100 μm. The width of the filtrate exit channel may also be a function of the quadrupole dimension, and the widths of the waste channels are just wide enough to account for the difference between the filtrate channel and the separation chamber.

In one example embodiment, the device has quadrupole heights/widths of 20 μm, separation channel widths of 200 μm, and waste channel angle of 30 degrees. The range of dimensions may only be limited on the small end by fabrication procedures and practicality due to increased flow resistance and lower throughput. High end dimensions may encounter a limit due to the voltage across the electrodes scaling with the square of the electrode spacing. Eventually the field strength may be high enough to form bubbles. A potential large size limit of the device may be on the order of 1 cm. However, further device and operational modifications may help overcome these potential practical size limits.

While one particular electrode arrangement is illustrated, a quadrupolar field can be made by application of opposite phase voltages to four hyperbolic shaped electrodes, or is often approximated with four round rods, and in the examples shown, is approximated by four flat electrodes. In still further embodiments, the quadrupolar field may be formed by an array of electrodes held at different potentials. Such a geometry may have an advantage of providing multiple stability zones across a large channel, which may prevent back diffusion into the center channel.

Sample losses due to vacuum interfacing and ionization can be extensive and are especially problematic for bulk collection in preparative mass spectrometry. Compared with gas phase operation, solution phase processing of charged particles may enhance the collection efficiency. Size-dependent confinement of charged particles in a flowing liquid produces separate filtered and waste streams.

In various embodiments, the device 100 consists of three layers. Top and bottom layers, comprised of metallic electrodes patterned onto fused silica or plastic substrates including PET (polyethylene terephthalate), PEEK (polyetheretherketone), polyimide, and Ultem® thermoplastic. The top and bottom layers are sandwiched around a middle layer to form the four-electrode layout to create a quadrupole trap. The middle layer, built upon the bottom one, is used to physically separate the top and bottom and also make the channel for fluid flow. The middle layer in one embodiment may be formed out of a laser cut Meltonix® material, a thermoplastic based on Dupont Surlyn® material. The middle layer may hold the channel shape and adheres to the top and bottom electrode layers. Laser cut channels in double sided Scotch® tape may also be used, but is only currently available in thicker layers (˜75 μm.) After subsequent dicing of both wafers and creating through holes for fluid connection on the top layer, the two substrates are bonded together to seal the device.

Preliminary Data

Due to the presence of a viscous medium the drag contributes an additional term to the equations of motion thus the conventional Mathieu's equation cannot be used. Applying a revised version reflecting the damping expands the region in which the solutions of the differential equation are stable. Unlike the gas phase, the damped solutions are governed not just by the mass and charge of a particle, but also the size of the particle, and fluid viscosity. Numerically solving the equations and obtaining stability diagrams by varying the damping factor enabled us to determine starting parameters for the inscribed quadrupole radius, voltage, frequency, viscosity, and particle mass, charge, and size.

In one embodiment utilized to obtain the preliminary data, AC and DC voltages are applied to the electrodes while dyed and carboxylate functionalized polystyrene beads suspended in DI water are flowed through the device. Optical microscopy and spectrophotometry are used for characterization. Our current device has a 7 μm radius. The beads, 1 μm in diameter and neutrally buoyant, have ˜10⁶ surface charges and are suspended in 18 MΩ-cm water. Calculations predict their trajectories will be confined within the quadrupolar field when the device is driven with 4 V at 2 MHz and 0.7 V DC. At 1 μL/s flow rate and a channel length of 1 mm the particles will be exposed to 2000 rf cycles during their residence time.

While one particular size and type of particle is described as an example, many other different sizes of particles and types of particles may be used. In some embodiments, one particle may be a drug scaffold that may be manufactured in various sizes. The device may be designed to separate out scaffolds of a specific identified size that has desired properties, such as a desired drug delivery profiles or capsules that open to release drugs on queue. In general, the frequency and voltage of the electrical signal applied to the electrodes to create the trap is inversely proportional to the size of the particles, whereas the size of the channel may be generally proportional to the size of the particle. Particles in some embodiments may vary in size between 10 nanometer to 1000 to 5000 nanometers.

The device may function in a continuous manner as opposed to batch operations provided by conventional filters. Continuous operation lends itself better for use in-line with continuous manufacturing processes. The device may serve as a high pass, low pass, or notch type filter, providing mostly particles of a desired size in the central channel. In some embodiments, multiple devices may be used in series to more effectively filter particles by size. Waste channels may be combined and further filtered with additional devices to separate out further particles of different desired sizes in still further embodiments.

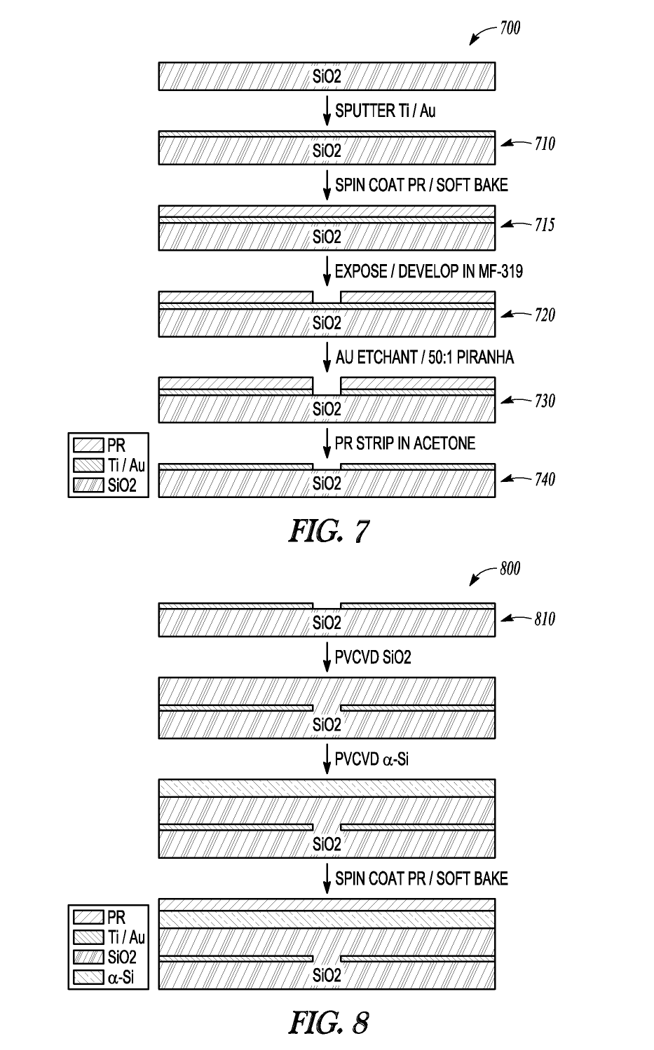

FIG. 7 is a block flow diagram illustrating electrode patterning at generally at 700 according to an example embodiment. Bilayers of Ti/Au are sputtered on fused silica at 710 and patterned using photolithography illustrated at 715, 720 followed by wet etching 730 using an Au etchant and a photoresist strip 740.

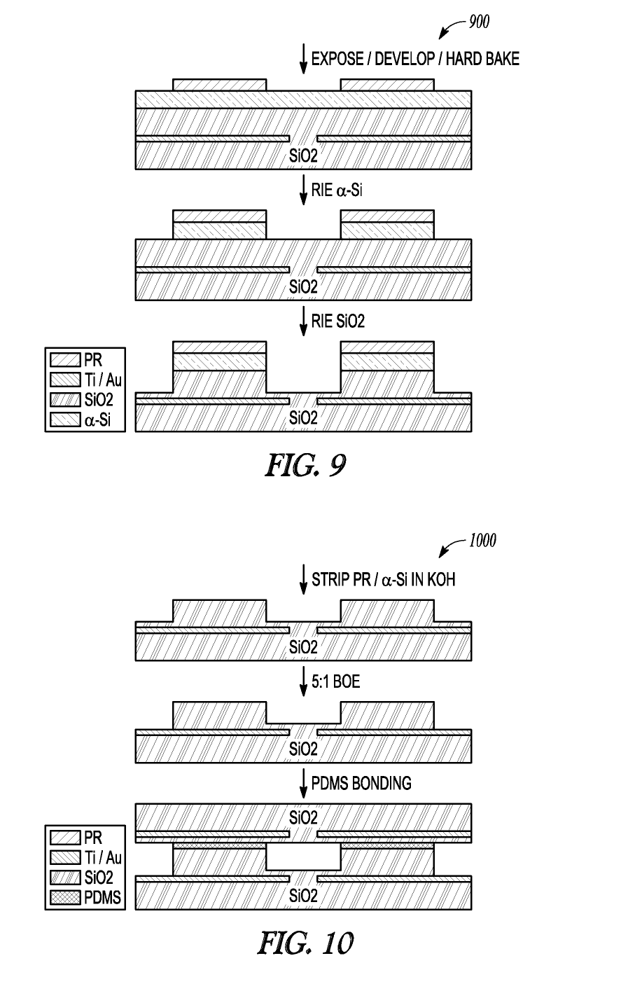

FIGS. 8 and 9 are block flow diagrams illustrating flow channel fabrication at generally at 800 and 900 according to an example embodiment. In the process shown in FIG. 8 and continued in FIG. 9, the middle channel layer is directly built on top of the bottom electrode. A fused silica wafer substrate is shown at 810 with a Ti/Au electrode forming the bottom electrode layer. Directly on top of this another layer of SiO2 is formed, and the rest of the process involves photolithographically patterning and etching the grown SiO2 into the desired channel geometry. Specifically PVCVD amorphous-Si and Spin coat PR/soft bake steps in the bottom of FIG. 8 illustrate deposition of a two layer mask. At the top of FIG. 9 a top PR layer is patterned using light. The PR pattern facilitates chemically etching/patterning the amorphous-Si layer, which then facilitates chemically etching/patterning the grown SiO2 layer.

In one embodiment, PDMS (polydimethylsiloxane) was initially selected as the middle layer, however the result of dry etching to reveal flow channels left residue bound to the substrate, leaving potential turbulence and clogging issues. SiO₂ serves better because it can be readily grown and dry etched, and prevents electrochemistry on the electrodes.

FIG. 10 is a block flow diagram illustrating sealing of the bottom electrode/middle channel layer generally at 1000. PDMS may be applied between the two wafers to act as an adhesive layer. During operation, it was observed that particles to be confined within the quadrupole, leaving minimal traces in the 100 μm-wide peripheral channel, was confirmed by a difference in absorbance by separately collecting output flows of the central and peripheral channels.

Alternative methods of flow channel and electrode fabrication may also be used, with the advantage of being performable without expensive and elaborate cleanroom procedures.

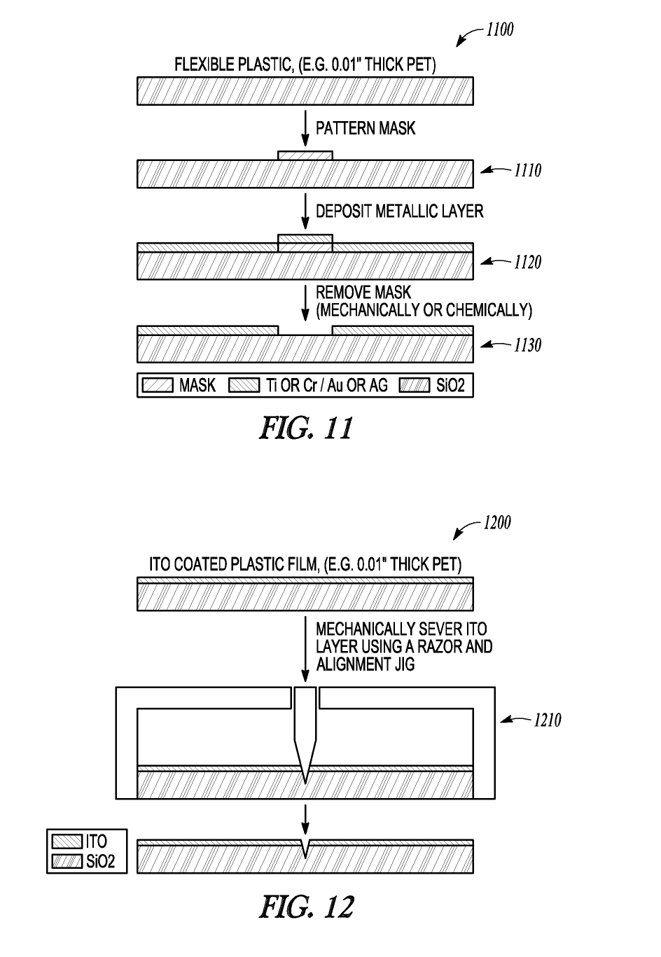

FIG. 11 is a block flow diagram illustrating electrode fabrication generally at 1100 on a plastic substrate according to an example embodiment. A pattern mask may be formed on a flexible plastic substrate, such as PET at 1110. A metallic layer may be formed at 1120 on the substrate and the mask removed at 1130.

In process 1100, robust devices may be made by sputtering either Ti/Au or Ag electrodes onto masked PET plastic film. The PET may be laser cut to form an outer device shape and provide tabs for electrical connection. The middle channel layer may be formed by laser cutting the channel geometry into 20 μm, 60 μm, or 100 μm Meltonix film. The Meltonix is sandwiched between the top and bottom PET/electrode layers and heated to 150° C. on a flat surface for 5 minutes under a 1 lb brass weight. The heating parameters are sufficient to cause slight melting of the Meltonix film, allowing for adhesion between the layers, but does not substantially deform the laser cut channel geometry.

FIG. 12 is a block flow diagram illustrating transparent electrode fabrication generally at 1200 according to an example embodiment. ITO, which is coated on an optically transparent plastic film such as PET may be mechanically severed at 1210 using a razor and alignment jig. In this second alternative method of fabrication 1000, an optically clear device may be formed for imaging particles while they are flowing through the channel. A 20 μm tip razor blade and jig may be used to cut a straight line through an ITO coating of commercially available ITO coated PET film. The straight line serves to form two separate ITO electrodes. The ITO/PET film is laser cut to form the outer geometry and tabs for electrical connection. Holes are cut in the top ITO/PET layer to form holes for fluid flow. The middle channel layer is laser cut into double sided Scotch® tape. The layers may be aligned by hand using a dissection microscope and pressed to form a seal.

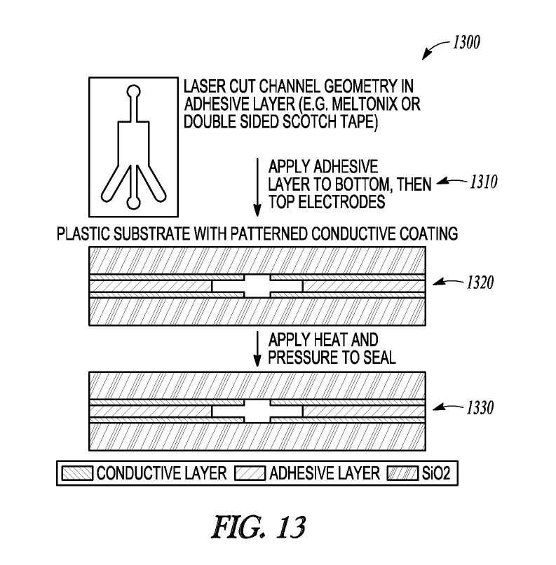

FIG. 13 is a block flow diagram illustrated channel fabrication for plastic substrate device generally at 1300 according to an example embodiment. Channel geometry may be cut by laser in an adhesive layer as indicated at 1310. The adhesive layer is then applied to the bottom and then top electrodes at 1320 and heat and pressure applied to seal the layers together at 1330. Heat and pressure parameters are easily determined based on the materials utilized.

Several applications utilize the device. Drug delivery particles in the nm to μm size regime can aid in drug delivery by protecting the drug from gastrointestinal degredation, crossing epithelial barriers, improving drug solubility, and by targeting organs and organelles in a size specific manner. Both the dose per particle and targeting depend on particle size, but the lack of an ability to prepare and characterize particles is one factor that has impeded progress.

HPLC (High Performance Liquid Chromatography) column packing: A source of peak broadening in packed particle bed liquid chromatography are inhomogeneities in particle packing that cause differences in the length and volume of the flow streams through the column. The inhomogeneities arise from a non-uniform size distribution and friction between particles during a downward-slurry packing method. The equilibrium structure for a uniform sample of spherical particles is a crystalline array. Improving the uniformity of particles is one step to improving packing homogeneity, along with changing the packing procedure to favor equilibrium structures.

Dense and homogenous battery electrodes: Packed nanoparticles yield faster charge injection rates than their bulk counterparts and can mitigate expansion/contraction stresses, but due to packing inefficiency charge transfer out of the electrode is compromised, limiting current flow. Similarly to the HPLC packing problem, particle uniformity and packing procedures are needed to solve this problem.

Organelle sorting: Biochemical analysis of protein activity depends on understanding localization within a cell. Currently used density centrifugation and immunoisolation methods are time consuming, inefficient, and expensive, which limits the throughput needed for systems biology studies requiring large data sets. Micro/electrofluidic strategies are promising, but limited in selectivity.

### EXAMPLES

1. A multiple layer device comprising:
a channel layer having a channel to carry a liquid having particles of multiple sizes;
a first electrode layer having a pair of first electrodes disposed about the channel;
a second electrode layer having a pair of second electrodes disposed about the channel, wherein the first and second electrode pairs are arranged to form a quadrupole about the channel when the electrodes are coupled to an electrical signal adapted to create a quadrupole trap.

2. The device of example 1 wherein the channel further comprises:
a central channel positioned to receive liquid and particles confined within a width and height of the central channel over a length of the quadrupole; and
a waste channel positioned to receive liquid and particles not confined within the length of the quadrupole.

3. The device of example 2 wherein the waste channel comprises two waste channels, each channel extending out opposite sides of the central channel in the channel layer proximate the end of the quadrupole. The word proximate is used to denote a proximity to the end of the quadrupole sufficiently close to the end of flow of the liquid that ejected particles do not have time to diffuse back into the central channel. The proximity will determine the effectiveness of the filtering function of the device. The closer to the trap, the fewer particles will have diffused back into the central channel.

4. The device of example 3 wherein the waste channels extend from the central channel at an angle less than 90 degrees to reduce liquid turbulence.

5. The device of example 4 wherein the waste channels are symmetrical about the central channel forming a “Y” shape.

6. The device of any of examples 2-5 wherein the waste channel comprises four waste channels, two of which extend out opposite sides of the central channel in the channel layer and two of which extend out opposite sides of the central channel away from the channel layer.

7. The device of any of examples 1-6 wherein the electrical signal has a frequency and voltage determined by the size of the particle to be captured in the trap. Given two particles of the same density and number of charges, the mass will scale fairly cleanly with frequency and voltage. But often when the size of a particle changes, so do the number of surface charges, so the clean relationship between size, frequency, and voltage can be lost. Further, there are two aspects to consider: whether a particle is trapped and how strongly it is trapped. Oddly enough increasing the voltage reduces the number of sizes that can be trapped, but the particles that are trapped are confined more strongly. The balance between the amount of particles confined and strength of confinement is worked out in the gas phase, but unknown in the liquid phase. Thus, the electrical signal has a frequency and voltage that can be determined by the size of the particle to be captured in the trap.

8. The device of any of examples 1-7 wherein the size of the channel is proportional to the size of the particle to be captured in the trap.

9. The device of any of examples 1-8 wherein the electrical signal frequency and voltage, the size of the channel, and the size of the particle to be trapped are determined in accordance with damped Mathieu's equations.

10. The device of example 9 wherein the particle size to be trapped is between 10 nm and 5000 nm.

11. The device of any of examples 1-10 wherein the particles comprise drug scaffolds.

12. The device of any of examples 1-11 wherein the electrodes are formed of conductive metal.

13. A method comprising:
providing a liquid having particles of various sizes to a channel sandwiched between segmented electrodes arranged to form a quadrupole about the channel;
applying an electrical signal to the segmented electrodes to create a quadrupole trap about a selected length of the channel such that particles of a selected size are captured by the quadrupole trap and other size particles are ejected away from the quadrupole trap;
providing an output stream of liquid and selected size particles in a central channel proximate the selected length of the channel;
removing liquid and the other size particles via a waste channel positioned proximate the selected length of channel.

14. The method of example 13 wherein the waste channel is formed of two waste channels that are symmetrical about the central channel.

15. The method of any of examples 13-14 wherein the electrical signal has a frequency and voltage determined by the size of the particle to be captured in the trap.

16. The method of any of examples 13-15 wherein the electrical signal frequency and voltage, the size of the channel, and the size of the particle to be trapped are determined in accordance with damped Mathieu's equations.

17. The method of any of examples 13-16 wherein the particles comprise drug scaffolds.

18. A method comprising:
forming a first segmented electrode layer on a substrate via metal sputtering and etching to form a first electrode having two pads connected by a rectangular section;
forming a channel layer on the first electrode layer, the channel layer having a channel crossing the rectangular section and changing into a central channel and two “Y” shaped peripheral waste channels;
forming a second segmented electrode layer on a substrate via metal sputtering and etching to form a second electrode having two pads connected by a second rectangular section; and
bonding the second electrode layer to the channel layer opposite the first electrode layer such that the electrode pads in each layer are positioned diagonally from each other and do not overlap with the other electrode pads, and wherein the rectangular sections of both electrode layers overlap to form a quadrupole.

19. The method of example 18 wherein the waste channels are formed at an angle of between 30 degrees and 60 degrees from the central channel.

20. The method of any of examples 18-19 wherein the electrodes are segmented about the separation channel.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The following statements are potential claims that may be converted to claims in a future application. No modification of the following statements should be allowed to affect the interpretation of claims which may be drafted when this provisional application is converted into a regular utility application.

1. A multiple layer device comprising:
a channel layer having a channel to carry a liquid having particles of multiple sizes;
a first electrode layer having a first pair of electrodes disposed about the channel;
a second electrode layer having a second pair of electrodes disposed about the channel, wherein the first and second electrodes are arranged to form a quadrupole about the channel when the electrodes are coupled to an electrical signal adapted to create a quadrupole trap.

2. The device of claim 1 wherein the channel further comprises:
a central channel positioned to receive liquid and particles confined within a width and height of the central channel over a length of the quadrupole; and
a waste channel positioned to receive liquid and particles not confined within the length of the quadrupole.

3. The device of claim 2 wherein the waste channel comprises two waste channels, each channel extending out opposite sides of the central channel in the channel layer proximate the end of the quadrupole.

4. The device of claim 3 wherein the waste channels extend from the central channel at an angle less than 90 degrees to reduce liquid turbulence.

5. The device of claim 4 wherein the waste channels are symmetrical about the central channel forming a “Y” shape.

6. The device of claim 2 wherein the waste channel comprises four waste channels, two of which extend out opposite sides of the central channel in the channel layer and two of which extend out opposite sides of the central channel away from the channel layer.

7. The device of claim 1 wherein the electrical signal has a frequency and voltage determined by the size of the particle to be captured in the trap.

8. The device of claim 1 wherein the size of the channel is proportional to the size of the particle to be captured in the trap.

9. The device of claim 1 wherein the electrical signal frequency and voltage, the size of the channel, and the size of the particle to be trapped are determined in accordance with damped Mathieu's equations.

10. The device of claim 9 wherein the particle size to be trapped is between 10 nm and 5000 nm.

11. The device of claim 1 wherein the particles comprise drug scaffolds.

12. The device of claim 1 wherein the electrodes are formed of conductive metal.

13. A method comprising:
providing a liquid having particles of various sizes to a channel sandwiched between two segmented electrodes arranged to form a quadrupole about the channel;
applying an electrical signal to the two segmented electrodes to create a quadrupole trap about the channel such that particles of a selected size are captured by the quadrupole trap and other size particles are ejected away from the quadrupole trap;
providing an output stream of liquid and selected size particles in a central channel proximate the quadrupole trap;
removing liquid and the other size particles via a waste channel positioned proximate the quadrupole trap.

14. The method of claim 13 wherein the waste channel is formed of two waste channels that are symmetrical about the central channel.

15. The method of claim 13 wherein the electrical signal has a frequency and voltage determined by the size of the particle to be captured in the trap.

16. The method of claim 13 wherein the electrical signal frequency and voltage, the size of the channel, and the size of the particle to be trapped are determined in accordance with damped Mathieu's equations.

17. The method of claim 13 wherein the particles comprise drug scaffolds.

18. A method comprising:
forming a first segmented electrode layer on a substrate via metal sputtering and etching to form a first electrode having two pads connected by a rectangular section;
forming a channel layer on the first electrode layer, the channel layer having a separation channel crossing the rectangular section and changing into a central channel and two “Y” shaped peripheral waste channels;
forming a second segmented electrode layer on a substrate via metal sputtering and etching to form a second electrode having two pads connected by a second rectangular section; and
bonding the second electrode layer to the channel layer opposite the first electrode layer such that the electrode pads in each layer are positioned diagonally from each other and do not overlap with the other electrode pads, and wherein the rectangular sections of both electrode layers overlap to form a quadrupole.

19. The method of claim 18 wherein the waste channels are formed at an angle of between 30 degrees and 60 degrees from the central channel.

20. The method of claim 18 wherein the electrodes are segmented about the separation channel.
